(19) United States
(12) Patent Application Publication
(10) Pub. No.: US 2019/0375519 A1
(43) Pub. Date: Dec. 12, 2019

(54) A SYSTEM FOR REAL TIME DETERMINATION OF PARAMETERS OF AN AIRCRAFT

(71) Applicant: Runweight Pty Ltd, Victoria (AU)

(72) Inventor: Bill Hartmann, Victoria (AU)

(73) Assignee: Runweight Pty Ltd, Victoria (AU)

(21) Appl. No.: 16/331,855

(22) PCT Filed: Aug. 7, 2017
(86) PCT No.: PCT/AU2017/050827

§ 371 Date: Mar. 8, 2019

(30) Foreign Application Priority Data
Sep. 9, 2016 (AU) 2016903644

(51) Int. Cl. B64F 1/36; B64F 5/60; B64D 45/00; G07B 15/06; G01G 19/07; G01M 1/12; G01L 17/00

(52) U.S. Cl. CPC B64F 1/36; B64F 5/60; B64D 45/00; B64D 2045/0085; G01G 19/07; G01M 1/127; G01L 17/005; G07B 15/063

(57) ABSTRACT

There is provided a system for determining real-time parameters of an aircraft, the system comprising: at least two sensing apparatus, each of the at least two sensing apparatus including a plurality of in-ground sensors; and at least one processing apparatus to process data received from the at least two sensing apparatus. It is preferable that a positioning of the at least two sensing apparatus is determined by a type of the aircraft being measured.

### FIELD OF INVENTION

Embodiments of the present invention relate to a system for real-time determination of parameters of an aircraft.

### BACKGROUND

Compliance with the weights and balance limits and requirements of any aircraft is critical to flight safety and operational efficiency. Operating beyond the maximum weight limitation adversely affects the structural integrity of an aircraft and performance. Furthermore, operation with the Centre of Gravity (CG) beyond the approved limits results in flight control difficulties.

Moreover, the incorrect or improper loading of an aircraft reduces the efficiency of an aircraft with respect to ceiling, maneuverability, rate of climb, speed, and fuel efficiency. If the aircraft is loaded in such a manner that it is extremely nose heavy, higher than normal forces will be required to be exerted at the tail end to keep the aircraft in a level flight. Conversely, if the aircraft is loaded in such a manner that it is extremely heavy at the tail, additional drag will be created, which will again require additional engine power, and consequently additional fuel flow in order to maintain airspeed.

However, it is typical that as aircraft age, their weights tend to increase from their factory weights, due to, for example, aircraft repainting without removal of old paint, accumulation of dirt/grease/oil in parts of the aircraft being cleaned/maintained, retrofitting of equipment, and so forth.

In addition, loads (including fuel) carried for every flight typically differ in relation to the weight and positioning of the loads.

In view of the above, it should also be noted that ambient environmental conditions such as, for example, wind speed/direction, air temperature, humidity, dewpoint, and so forth also affect aircraft flight characteristics, but at this juncture, the assessment of ambient environmental conditions is not carried out quantitatively.

Thus, it is evident that there are some shortcomings in relation to determining real time parameters of aircraft, prior to take-off and subsequent to landing.

### SUMMARY

There is provided a system for determining real-time parameters of an aircraft, the system comprising: at least two sensing apparatus, each of the at least two sensing apparatus including a plurality of in-ground sensors; and at least one processing apparatus to process data received from the at least two sensing apparatus. It is preferable that a positioning of the at least two sensing apparatus is determined by a type of the aircraft being measured.

Preferably, the in-ground sensors comprises weight sensors; and presence sensors.

It is preferable that each of the sensing apparatus further includes imaging sensors, the imaging sensors being configured to enable identification of the aircraft.

The at least two sensing apparatus are preferably positioned in a row to enable determination of presence of an aircraft, aircraft separation, speed measurement and aircraft classification.

The system can further include at least one weather determination station, the at least one weather determination station being to obtain at least one weather parameter selected from, for example, apparent wind speed, wind direction, air temperature, pavement temperature, relative humidity, pavement humidity, barometric pressure, heat index, wind chill, ceilometer, lateral and longitudinal wind draft, air density and so forth.

The system can also further include a visual display apparatus configured to indicate the real time parameters of the aircraft.

Preferably, the at least one processing apparatus is configured to carry out at least one of the following tasks, such as, for example, loop detection, direction detection, speed detection, force detection based on frequency, speed acquisition, determination of acceleration of the aircraft, determination of deceleration of the aircraft, compensating input signals to external parameters, conditioning input signals to external parameters, linearizing of input signals to external parameters, and so forth.

The real time parameters are preferably selected from a group such as, for example:
(a) the aircraft's individual tire weight, mass/force;
(b) all individual bogies/axles weight, mass/force;
(c) accumulated lateral tyre(s)/bogie(s)/axle(s) weight, mass/force;
(d) accumulated longitudinal tyre(s)/bogie(s)/axle(s) weight, mass/force;
(e) total accumulated weight, mass/force of all tyre(s)/bogie(s)/axle(s);
(f) lateral tyre(s)/bogie(s)/axle(s) weight, mass/force distribution;
(g) longitudinal tyre(s)/bogie(s)/axle(s) weight, mass/force distribution;
(h) maximum take off weight, mass/force;
(i) longitudinal centre of gravity;
(j) lateral centre of gravity;
(k) total centre of gravity;
(l) tyre detection;
(m) aircraft speed;
(n) validation of constant velocity of the aircraft;
(o) tyre inflation irregularities;
(p) identification indicia pertaining to the aircraft;
(q) left to right aircraft loading balance information and distribution;
(r) fore to aft aircraft loading balance information and distribution; and
(s) the aircraft loading and balance information and distribution.

Preferably, the real-time parameters determine a toll payable for the aircraft, the toll being for utilising an aircraft landing venue.

In a second aspect, there is provided a method for determining a toll payable for an aircraft, the toll being for utilising an aircraft landing venue, the method comprising: measuring real-time parameters of the aircraft; and determining the toll for the aircraft based on the real-time parameters of the aircraft.

In a third aspect, there is provided a method for determining a landing fee payable for an aircraft, the landing fee being for utilising an aircraft landing venue, the method comprising: measuring real-time parameters of the aircraft; and determining the landing fee for the aircraft based on a duration that the aircraft is at the aircraft landing venue, the duration being measured from a juncture when measuring the real-time parameters of the aircraft.

### DESCRIPTION OF FIGURES

In order that the present invention may be fully understood and readily put into practical effect, there shall now be described by way of non-limitative example only, certain embodiments of the present invention, the description being with reference to the accompanying illustrative Figures, in which:

FIGS. 1a to 1f show various embodiments of a system of the present invention.

FIG. 2 shows a schematic diagram of a sensing apparatus of the system of the present invention.

FIG. 3 shows a process flow of a crystal/quartz/piezo sensing apparatus of the system of the present invention.

FIG. 4 shows a process flow of a force sensing apparatus of the system of the present invention.

FIG. 5 shows a process flow of operations of the system of the present invention.

FIG. 6 shows a process flow of processing of aircraft records.

FIGS. 7a to 7b is a flowchart depicting the comprehensive operation of the system depicted in FIG. 1a.

FIGS. 8a to 8b is a flowchart depicting the comprehensive operation of the system depicted in FIG. 1b.

FIGS. 9a to 9b is a flowchart depicting the comprehensive operation of the system depicted in FIG. 1c.

FIG. 10 is a flowchart depicting the comprehensive operation of the system depicted in FIG. 1d.

FIG. 11 is a flowchart depicting the comprehensive operation of the system depicted in FIG. 1e/f.

### DETAILED DESCRIPTION

Embodiments of the present invention provide a system for determining real-time parameters of an aircraft. Determination of the real-time parameters of the aircraft enables, for example, an aircraft dynamic up weighing cross-checking/monitoring/warning system, an aircraft tolling system, an aircraft live weights and balances monitoring/cross-checking/warning system, any combination of the aforementioned, and so forth. The system can be of a permanently installed or a portable type.

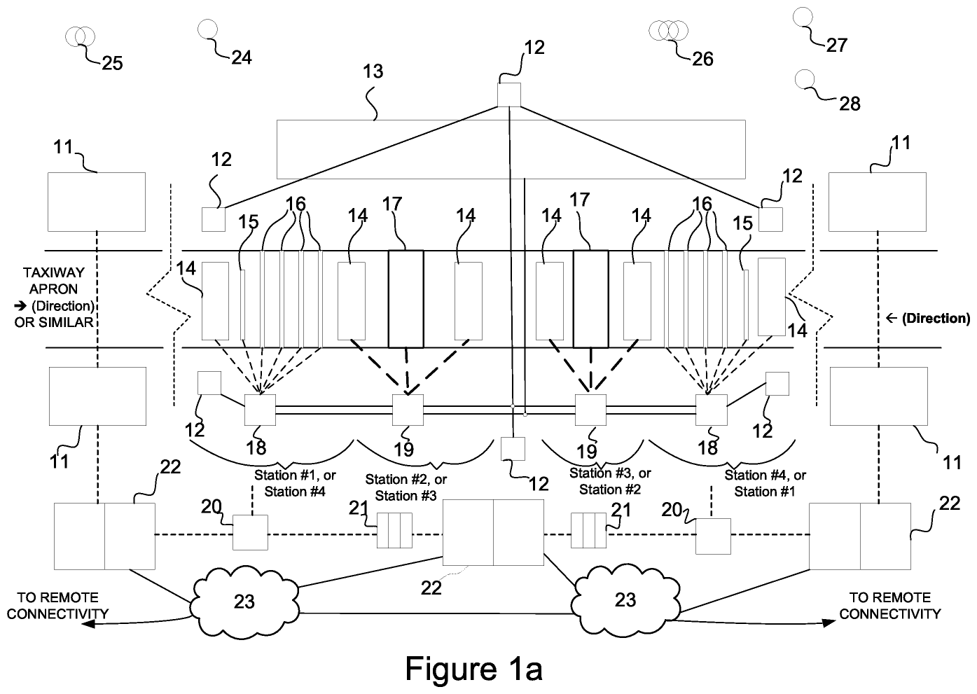

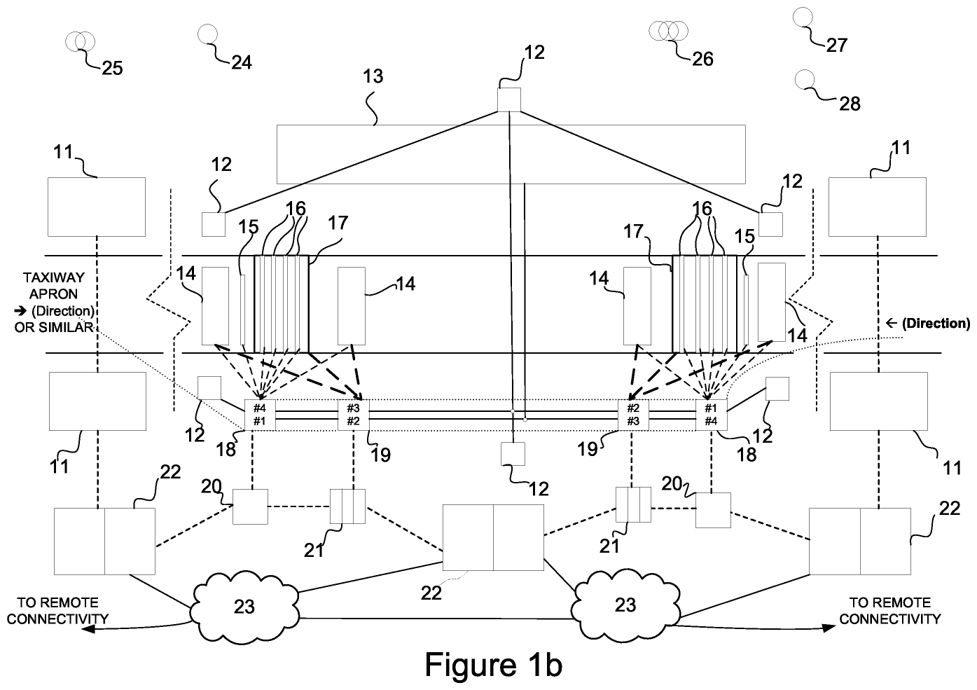

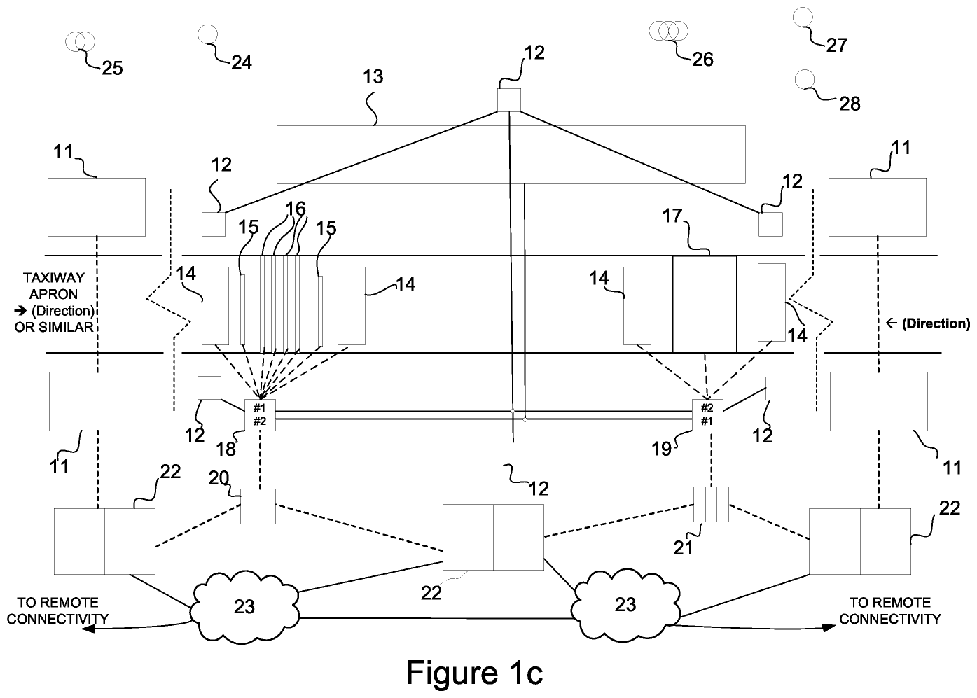

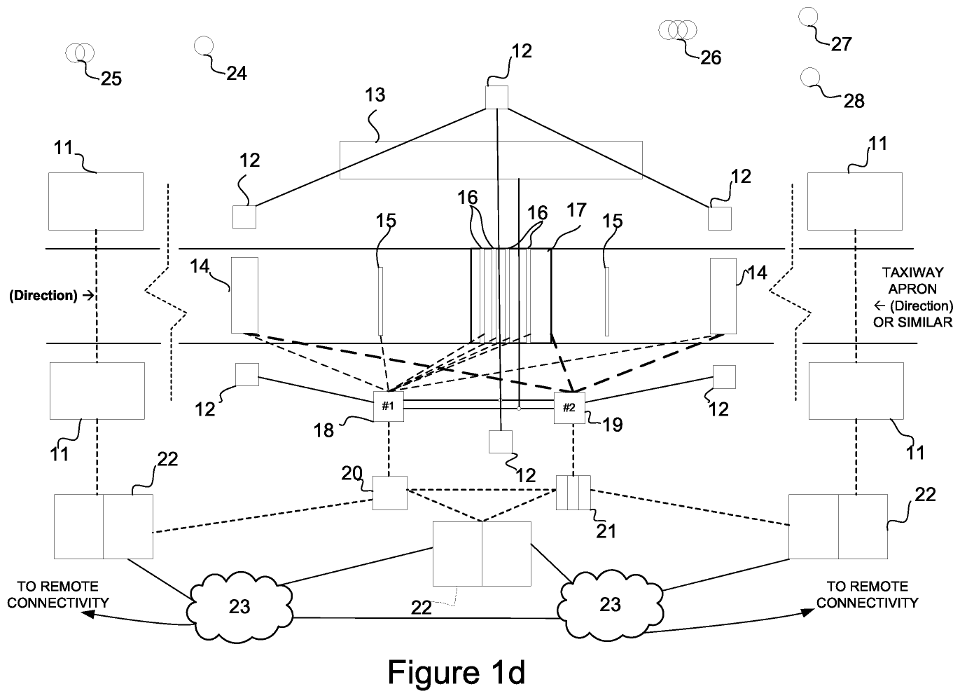

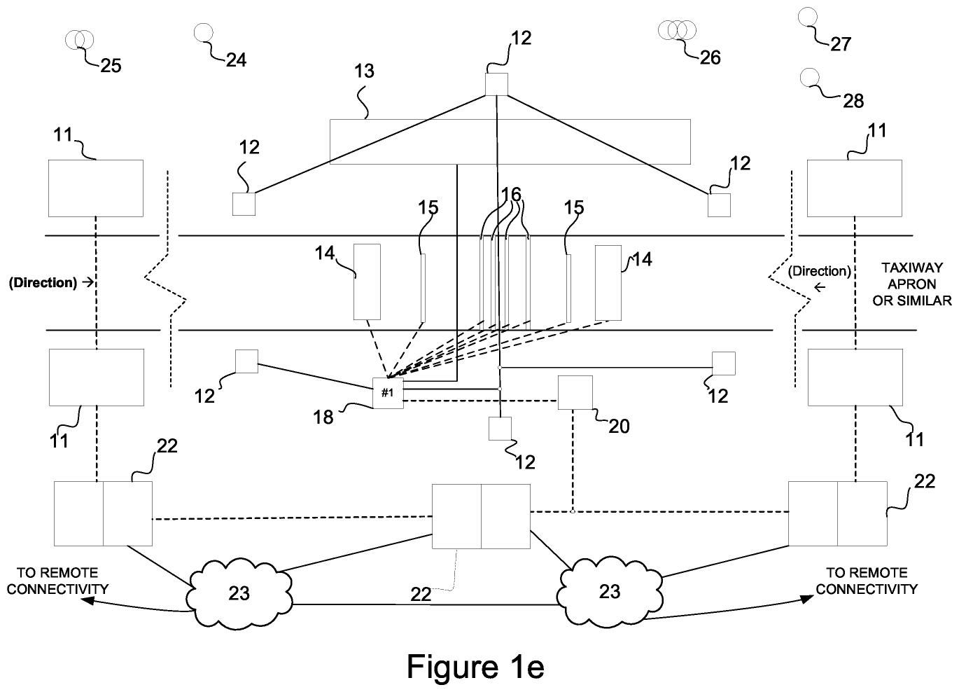

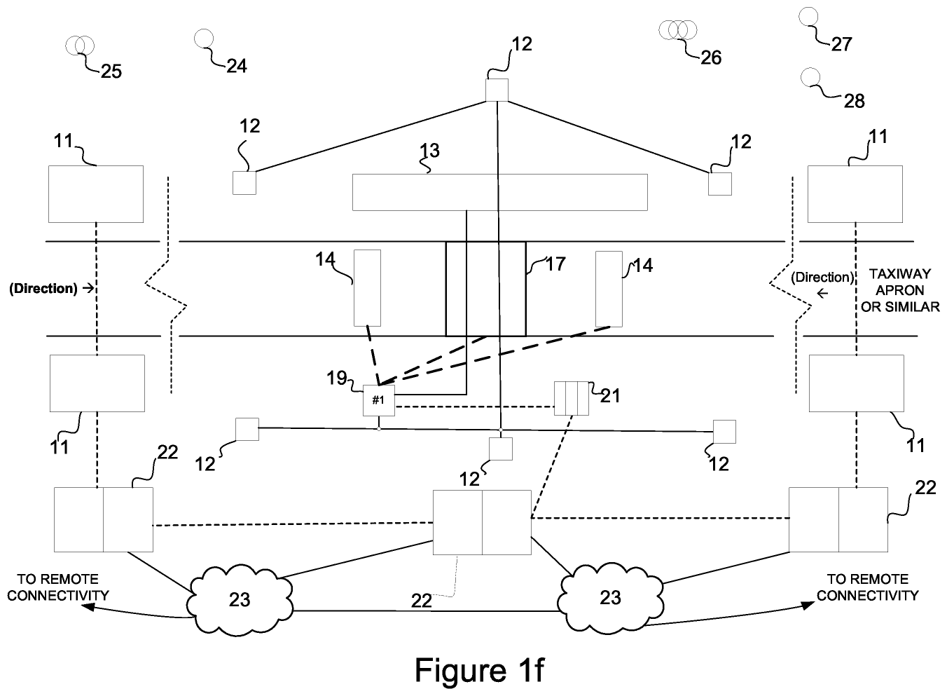

Various embodiments of the system are shown in FIGS. 1a to 1f. The various embodiments are dependent on, for example, a footprint size of aircraft, weight of aircraft, surface type of taxiway, financial constraints of installation and so forth. It should be appreciated that the various embodiments of the system can be in a form of a single platform/plane for locating requisite sensors/readers for obtaining various parameters of the aircraft, or it can be in a form of multiple platforms/planes for locating requisite sensors/readers for obtaining various parameters of the aircraft.

The respective items deployed in the various embodiments depicted in FIGS. 1a to 1f are as follows:
Items 15 and 16: At least one station of crystal/piezo/quartz sensors.
Item 17: Crystal/piezo/quartz sensors and force sensors producing real-time up weight signals.
Item 13: Meteorological sensors to compensate/condition input from 15, 16, 17 from external or prevalent factors as apparent wind speed, wind direction, air temperature, pavement temperature, relative humidity, pavement humidity, barometric pressure, heat index, wind chill, ceilometer, lateral and longitudinal wind draft, air density and so forth.
Item 12: Cameras to obtain an overview and the registration, identification (ID) and speed of the aircraft.
Item 14: Inductive, capacitive and/or pressure loops, used to ascertain the presence of an aircraft, aircraft separation, speed measurement and aircraft classification.
Item 11: Visual Message System (VMS) can be a light emitting diode (LED) based display(s) screen (monochrome or full colour) to display real-time parameters of the aircraft or runweight solution intelligence to a pilot/related crew/controlling authorities pertaining to the aircraft prior to departure. The VMS can be a tablet/ipad or similar device and possibly even on-board computers/systems. Alternatively, the VMS can be a large external scoreboard type remote display attached to a building or a stand-alone structure viewable from a cockpit of an aircraft.
Item 18: Crystal/quartz/piezo signal processor, charge amplifier, central processing unit and weigh in motion or dynamic weighing units which has requisite electronics and components for loop detection, direction detection, speed detection, force detection based on frequency, speed acquisition, the capability to ascertain acceleration or deceleration and the relevant value, compensation, conditioning and/or linearization of input signals to external parameters, with software and for the sensors and camera intelligence, a database and an internet/web based interface, which are used to ascertain all primary signals.
Item 19: Force signal processor, central processing unit and weigh in motion or dynamic weighing units which have requisite electronics and components for loop detection, direction detection, speed detection, force detection, compensation, conditioning and/or linearization of input signals to external parameters, with software and for the sensors and camera intelligence, a database and an internet/web based interface, which are used to ascertain all primary signals.
Item 20: Centre of gravity unit for the crystals/quartz/piezo system to compute, calculate and determine real-time centre of gravity (CG) for, firstly, lateral component, then longitudinal component and finally a total centre of gravity under real-time prevalent conditions.
Item 21: Centre of gravity unit for the force system to compute, calculate and determine real-time centre of gravity (CG) for, firstly, lateral component, then longitudinal component and finally a total centre of gravity under real-time prevalent conditions.
Item 22: Computational System(s), which can consist of three or more computers with requisite software for each station and signal type and station type and/or supporting station periphery and related hardware supporting accessories or peripherals as monitors, keyboards, drives, back-ups, interconnectivity as Wireless, Local Area Network (LAN), Wide Area Network (WAN), modem, or similar network or communication interfacing or connectivity (Satellite, TCP/IP, Ethernet, fibre optic, RS232, RS422, RS485, NMEA, NMEA 0183, SDI-12, Gill ASCII, ASCII, DOS, USB, direct computer to computer, or any similar digital, analog or similar protocol), and one or more media converters are used, in which the computational system(s) does all required data processing and local onsite memory and/or data backup to ascertain all data and signal outputs are correct, validated with a regulatory database pertaining this information, and that it is safe to have the aircraft take off or later land, and further to ascertain that if there are issues, that corrective action with respect to irregular, incorrect or abnormal data of the following parameters can be actioned upon:
Real-time Maximum Take Off Weight (MTOW)/All Up Weight/RunWeight;
Centres of gravity;
Weights and balances;
Tyre pressure status;
Volume/weight conversion anomalies;
Signature of individual tyre inflation status;
Real-time individual tyre weight/mass/force and distribution;
Weight/mass and/or force and distribution thereof acting on the surface of tyre contact,
Real-time individual bogie/axle tyre force and, weight and/or mass and distribution thereof acting on the surface of bogie/axle tyre contact;
Real-time lateral tyre force and, weight and or mass and distribution thereof acting on the lateral surface of tyre contact;
Real-time longitudinal tyre force and, weight and or mass and distribution thereof acting on the longitudinal surface of tyre contact;
Real-time MTOW;
Real-time total/gross/landing weight of the aircraft;
Weight/mass classification of aircraft;
Aircraft real-time lateral/longitudinal centre of gravity;
Aircraft real-time up weight centre of gravity (CG)/MTOW centre of gravity (Combination of real-time lateral CG and longitudinal CG);
Validation on fuel balance;
Provision of a final cross-check of the validity of the partially calculated and weighed MTOW obtained from relevant airport/maintenance operations, and the weights and balances log book. Note that real-time all up weight (RUNWEIGHT)=Basic empty weight (BEW)+Operational items weight+Passengers+Carry-on weight+Checked baggage weight+Cargo weight+Reserve fuel weight+Trip fuel weight+Taxi out and take off fuel weight
Item 23: The Internet or a data network for use by users such as, authorised pilots, clients (airport, airlines and/or related operators thereof), authorities, regulatory bodies, investigative authorities and associations, and so forth.
Item 27: Local and offsite back up repository.
Item 28: For post operation use and further research and development.
Item 24: A mobile static weights and balances device or unit, data of which is used to determine and/or calculate and/or validate/verify and/or acquire the following pertaining to the aircraft:
   Aircraft operating limits;
   Arm (moment arm);
   Ballast;
   Basic empty weight (BEW);
   Cargo weight;
   Centre of gravity (CG);
   CG limits;
   CG range;
   Checked baggage weight;
   Empty weight;
   Empty weight CG;
   Fuel load;
   Licensed empty weight;
   Maximum landing weight (MLW);
   Maximum ramp weight;
   Maximum take off weight (MTOW)
   Maximum weight;
   Maximum zero fuel weight;
   Minimum fuel;
   Moment;
   Operational items weight;
   Passengers and carry-on weight;
   Payload;
   Reserve fuel weight;
   Standard empty weight;
   Take off fuel weight;
   Taxi out fuel weight;
   Trim setting;
   Trip fuel weight;
   Useful load.
Item 25: A mobile calibration unit used for static runweight calibration of the crystal/quartz/piezo sensors and/or the signal conditioning and/or processing and/or charge amplifier devices or units.
Item 26: A mobile calibration unit used for static runweight calibration of the force sensors and/or force signal conditioning and/or processing devices or units.

It should be appreciated that the respective items are deployed to function in a manner as described above, and the task of putting together all the items to operate in a desired manner entails substantial assessment, and research. It should be noted that the putting together of the respective items leads to operative synergy which brings about more functionalities than what is provided by the individual respective items.

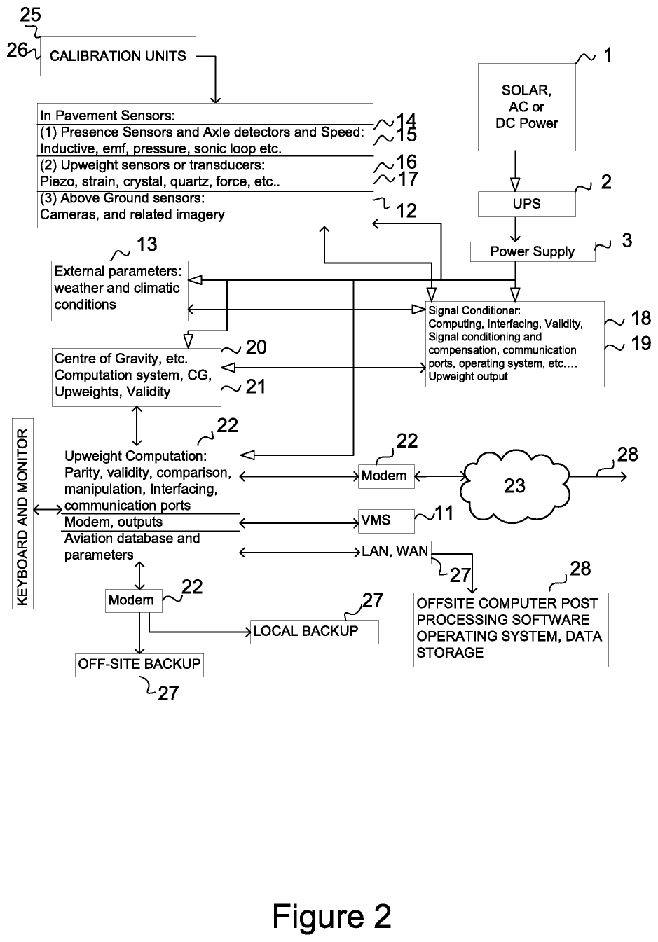

Referring to FIG. 2, there is shown a schematic diagram of a plurality of sensing apparatus of the system of any of the aforementioned embodiments. The schematic diagram shows both the respective items of the sensing apparatus, as well as data flow amongst the respective items. There is shown, in FIG. 2, calibration units 25, 26, processing data obtained from in-pavement sensors 14, 15, 16, 17, 12, and whereby the processed data is transmitted to the signal conditioner 18, 19. A power source 1 for the signal conditioner 18, 19, can be coupled to an uninterrupted power supply 2, to provide a power supply 3. Data from the meteorological sensors 13 are transmitted to the CG units 20, 21 such that the requisite data can be processed by the computational systems 22 for further transmission via the data network 23, the local/offsite back up repository 27 or displayed on the VMS 11.

It should also be appreciated that a direction of taxi-ing is determined by a first trigger received from the in-pavement sensors 14, 15, 16, 17, 12 of the installed loop. This is used to ascertain and assign weighing location identification for LHS, RHS, FORE & AFT data. Using this data, it is possible to obtain a concise signature layout of the aircraft and dimensional layout (eg. distances for moments and arms). The time and speed is used to calculate this and dedicates relevant weight and balance information accordingly.

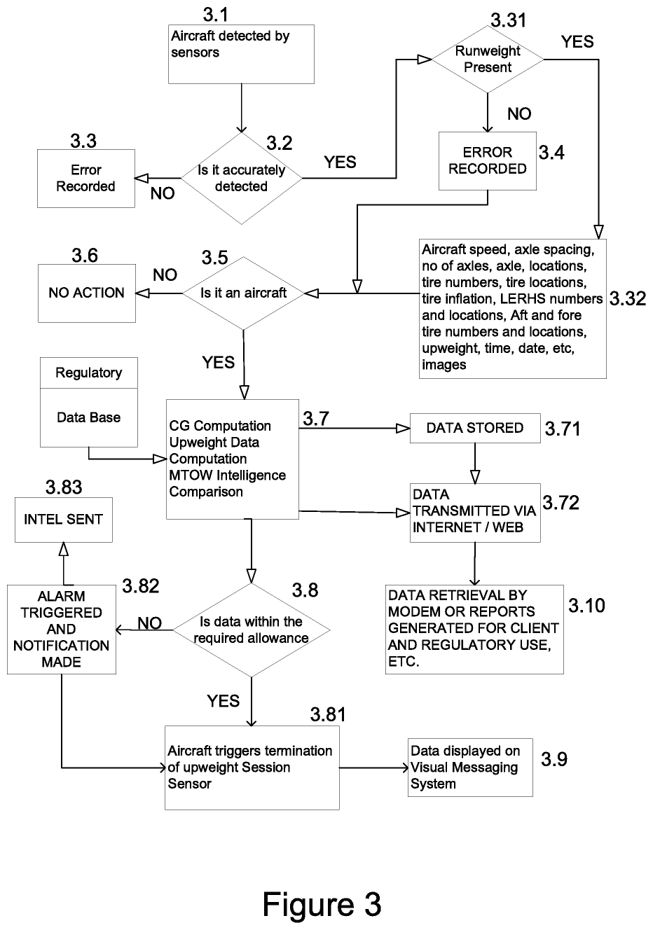

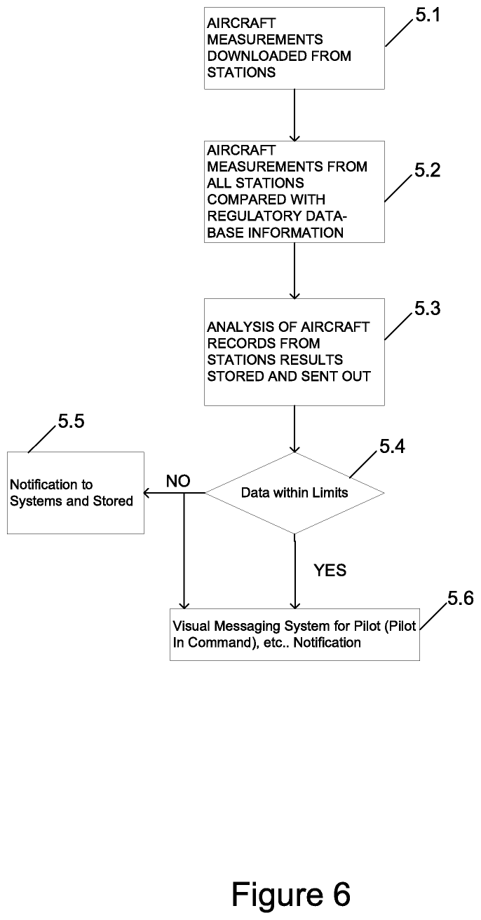

Referring to FIGS. 3 to 6, there are shown processes which are specific to embodiments of the system are shown in FIGS. 1a to 1f, particularly in relation to a number of sensors that are used, and configuration/layout of the sensors.

In FIG. 3, there is shown a process flow for showing how data is displayed on a visual messaging system. Firstly, it is determined if an aircraft is detected by sensors (3.1). Then an assessment is carried out if the aircraft is detected accurately (3.2). If no, an error is recorded (3.3). If yes, an assessment is carried out if runweight is present (3.31). If no, an error is recorded (3.4). If runweight is present, measurements are carried out for, for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth (3.32).

Subsequently, an assessment is made whether the detected aircraft is indeed an aircraft or some other vehicle/object (3.5). If no, the process ceases (3.6). If yes, the measurements are processed and compared (3.7). The processed data is stored (3.71) and/or transmitted via a network (3.72) for subsequent retrieval for use for various purposes (3.10).

Then an assessment is carried out if the aircraft is detected accurately (3.8). If no, an alarm is triggered (3.82) and transmitted to a network (3.83). If yes, runweight measurement process is terminated (3.81) and the measured data is displayed on the visual messaging system (3.9). If no, an error is recorded (8.12.1).

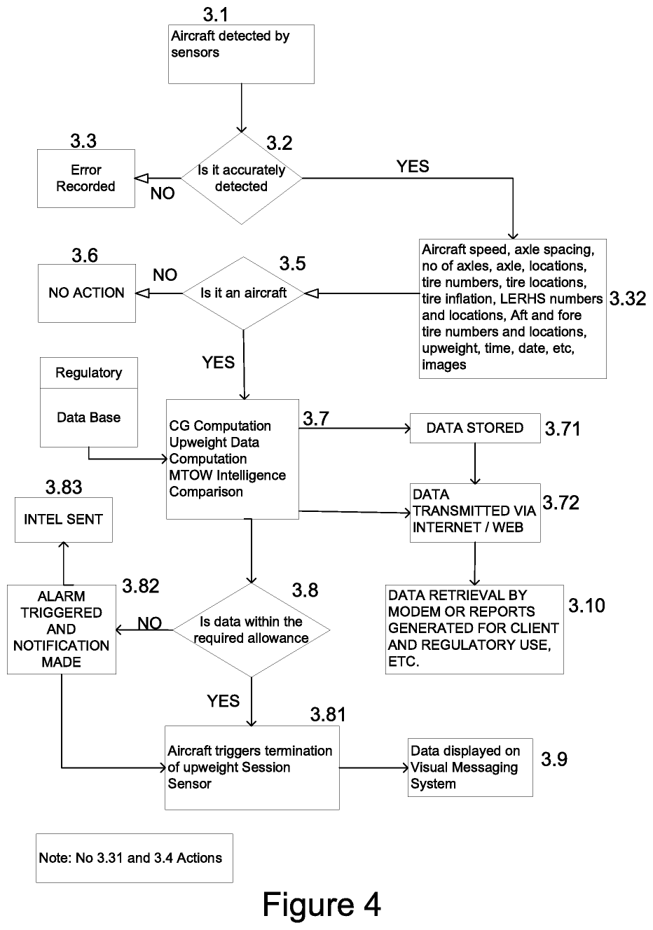

In FIG. 4, an identical process as FIG. 3 is shown, except that steps 3.31 and 3.4 are omitted.

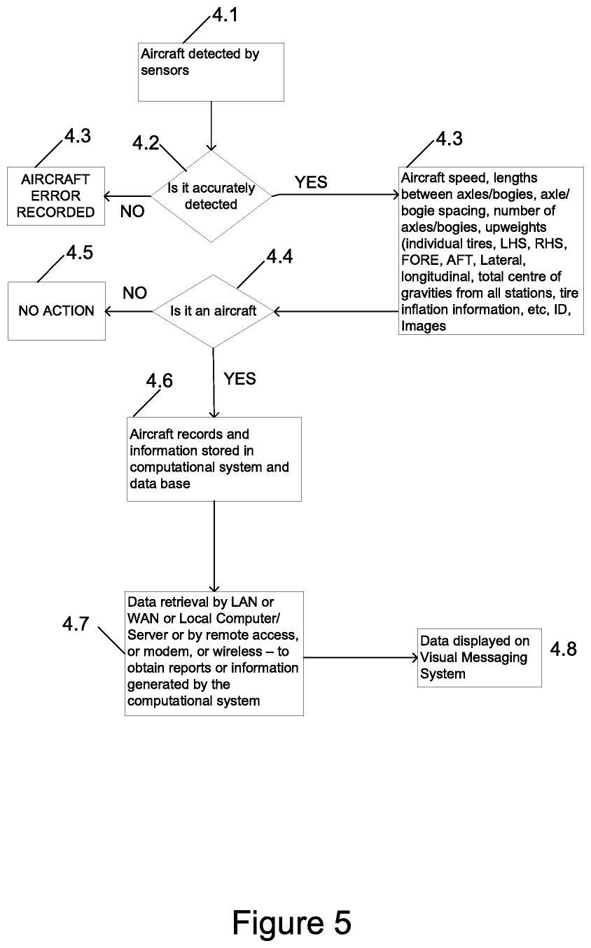

In FIG. 5, a more streamlined process compared to the process shown in FIG. 3 is shown. Firstly, an aircraft is detected by sensors (4.1). Then an assessment is carried out if the aircraft is detected accurately (4.2). If no, an error is recorded (4.3). If yes, measurements are carried out for, for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth (4.3).

Subsequently, an assessment is made whether the detected aircraft is indeed an aircraft or some other vehicle/object (4.4). If no, the process ceases (4.5). If yes, the measurements are processed and stored (4.6). Subsequently, data is retrieved to obtain reports (4.7), and the measured data is displayed on the visual messaging system (4.8).

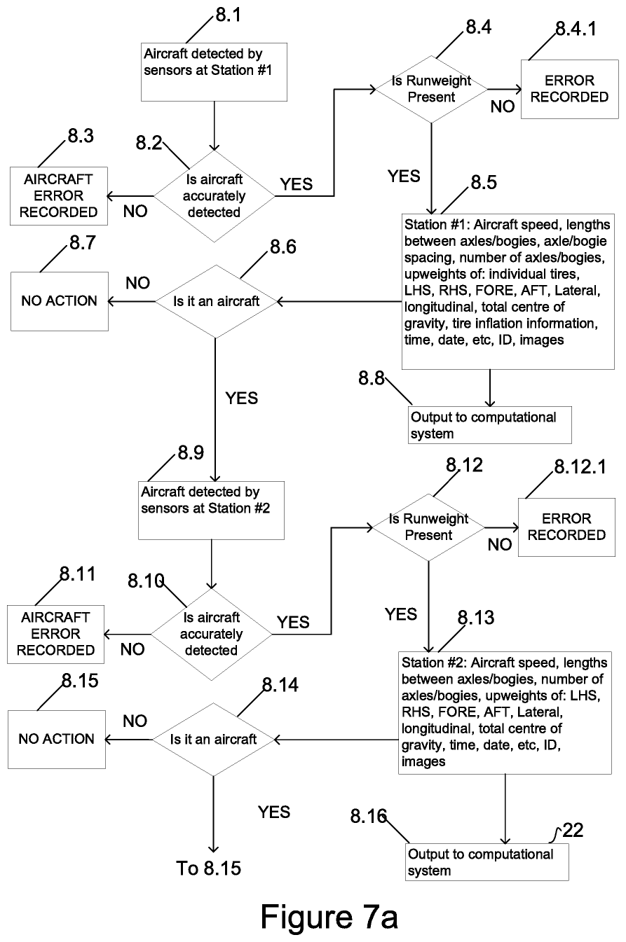

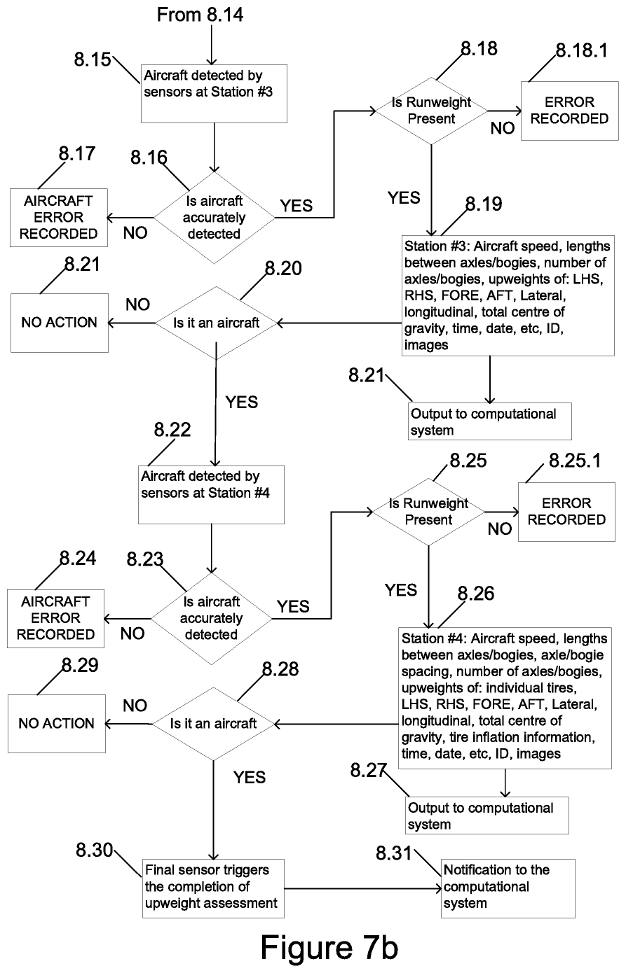

In FIG. 7, there is shown another streamlined process compared to the process shown in FIG. 3. Firstly, the aircraft measurements are downloaded from sensors (5.1), and the measurements are subsequently compared to information from the requisite regulators (5.2). The comparison findings are stored and transmitted (5.3), and an assessment is then made to determine if the data is within allowable limits (5.4). If no, a negative notification is sent to the visual messaging system (5.6) and stored (5.5). If yes, a positive notification is sent to the visual messaging system (5.6).

Referring to FIGS. 7a to 7b, there is shown a process flow of the system depicted in FIG. 1a. Firstly, it is determined if an aircraft is detected at station 1 (8.1). Then an assessment is carried out if the aircraft is detected accurately (8.2). If no, an error is recorded (8.3). If yes, an assessment is carried out if runweight is present (8.4). If no, an error is recorded (8.4.1). If runweight is present, measurements are carried out at station 1 (8.5), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data is then output to the computational system (8.8).

Subsequently, an assessment is made whether the detected aircraft is indeed an aircraft or some other vehicle/object (8.6). If no, the process ceases (8.7). If yes, the aircraft is subsequently detected at station 2 (8.9). Then an assessment is carried out if the aircraft is detected accurately (8.10). If no, an error is recorded (8.11). If yes, an assessment is carried out if runweight is present (8.12). If no, an error is recorded (8.12.1). If runweight is present, measurements are carried out at station 2 (8.13), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data is then output to the computational system (8.16).

Subsequently, another assessment is made whether the detected aircraft is indeed an aircraft or some other vehicle/object (8.14). If no, the process ceases (8.17). If yes, the aircraft is subsequently detected at station 3 (8.15). Then an assessment is carried out if the aircraft is detected accurately (8.16). If no, an error is recorded (8.17). If yes, an assessment is carried out if runweight is present (8.18). If no, an error is recorded (8.18.1). If runweight is present, measurements are carried out at station 3 (8.19), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data is then output to the computational system (8.21).

Subsequently, yet another assessment is made whether the detected aircraft is indeed an aircraft or some other vehicle/object (8.20). If no, the process ceases (8.21). If yes, the aircraft is subsequently detected at station 4 (8.22). Then an assessment is carried out if the aircraft is detected accurately (8.23). If no, an error is recorded (8.24). If yes, an assessment is carried out if runweight is present (8.25). If no, an error is recorded (8.25.1). If runweight is present, measurements are carried out at station 4 (8.26), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data is then output to the computational system (8.27). A final assessment is carried out to determine whether the detected aircraft is indeed an aircraft or some other vehicle/object (8.28). If no, the process ceases (8.29). If yes, the final sensor triggers completion of the assessment (8.30) and a notification is provided to the computational system (8.31). The final sensor is a loop and/or a camera, or a combination thereof, which will be located a calculated distance from the last runweight weight & balance sensing device. The precise distance will be calculated and configured for installation based on an aircraft traversing speed (no acceleration or deceleration) range of 3 to 15 km/h.

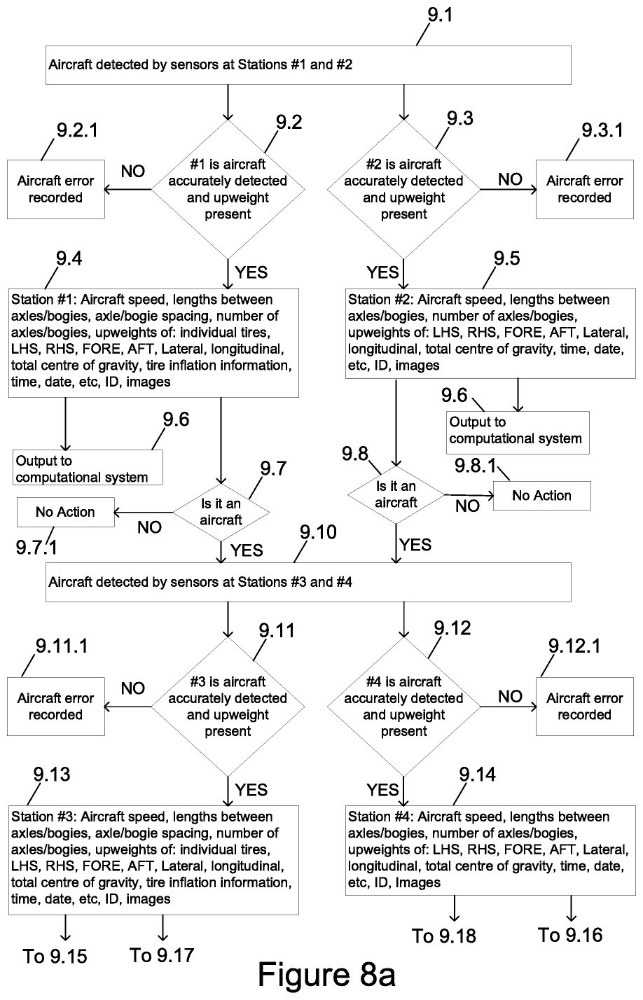

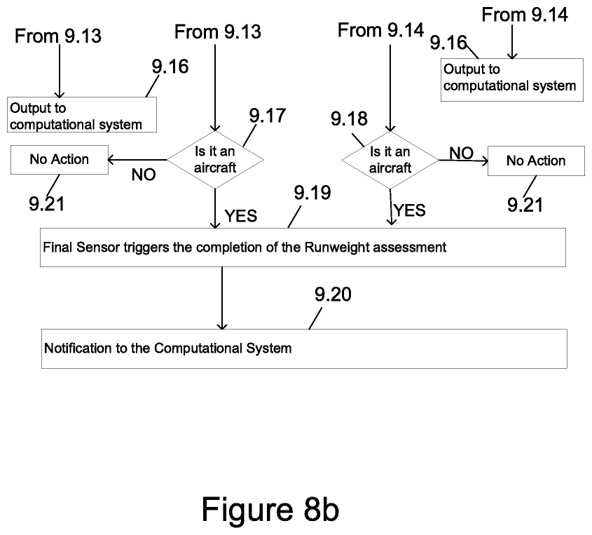

Referring to FIGS. 8a to 8b, there is shown a process flow of the system depicted in FIG. 1b. Firstly, the aircraft is detected at stations 1 and 2 (9.1). Simultaneously, station 1 and 2 respectively assess the aircraft and detect if the aircraft and runweight are present (9.2, 9.3). If station 1 does not detect either, an error is recorded and the process ceases (9.2.1). If station 2 does not detect either, an error is recorded and the process ceases (9.3.1).

If both stations 1 and 2 detect the presence of the aircraft and runweight, measurements are carried out at each respective station (9.4, 9.5), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data from each station is then output to the computational system (9.6).

Subsequently, an assessment is made by each station whether the detected aircraft is indeed an aircraft or some other vehicle/object (9.7, 9.8). If no, the process ceases (9.7.1, 9.8.1). If yes, the aircraft is subsequently detected at stations 3 and 4 (9.10). Simultaneously, station 3 and 4 respectively assess the aircraft and detect if the aircraft and runweight are present (9.11, 9.12). If station 3 does not detect either, an error is recorded and the process ceases (9.11.1). If station 4 does not detect either, an error is recorded and the process ceases (9.12.1).

If both stations 3 and 4 detect the presence of the aircraft and runweight, measurements are carried out at each respective station (9.13, 9.14), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data from each station is then output to the computational system (9.16).

A final assessment is carried out at each station 3 and 4 to determine whether the detected aircraft is indeed an aircraft or some other vehicle/object (9.17, 9.18). If no, the process ceases (9.21). If yes, the final sensor triggers completion of the assessment (9.19) and a notification is provided to the computational system (9.20). The final sensor is a loop and/or a camera, or a combination thereof, which will be located a calculated distance from the last runweight weight & balance sensing device. The precise distance will be calculated and configured for installation based on an aircraft traversing speed (no acceleration or deceleration) range of 3 to 15 km/h.

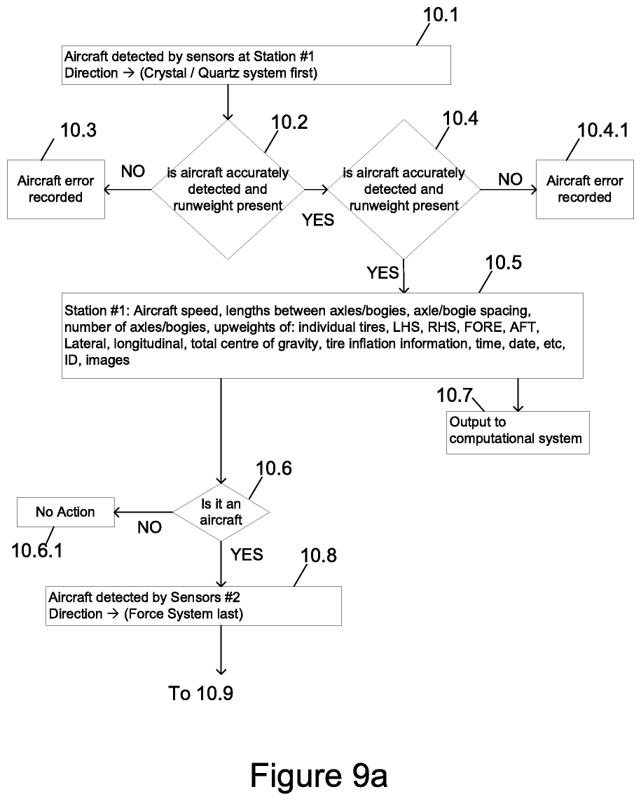

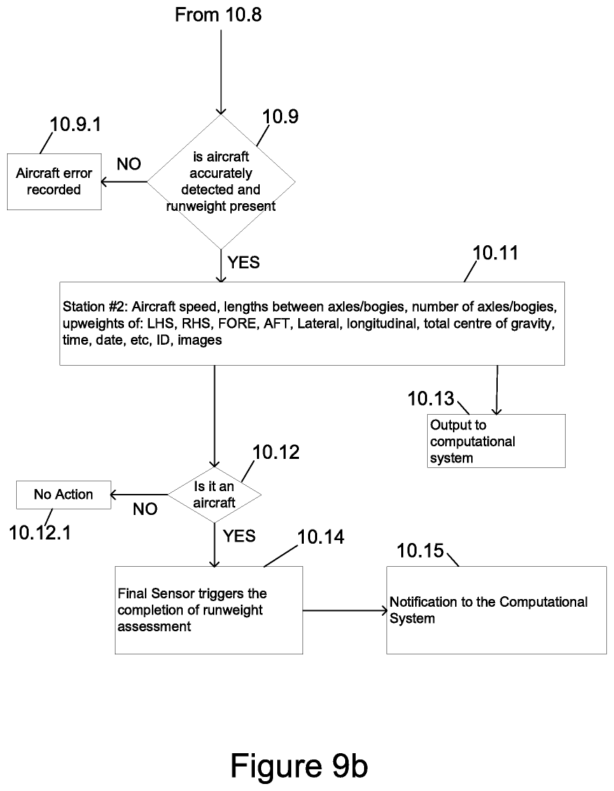

Referring to FIGS. 9a to 9b, there is shown a process flow of the system depicted in FIG. 1c. Firstly, the aircraft is detected at station 1, firstly with crystal sensors followed by quartz sensors (10.1). The crystal sensors assess the aircraft and detect if the aircraft and runweight are present (10.2). If the crystal sensors do not detect either, an error is recorded and the process ceases (10.3). If the crystal sensors detect both, subsequently, the quartz sensors then assess the aircraft and detect if the aircraft and runweight are present (10.4). If the quartz sensors do not detect either, an error is recorded and the process ceases (10.4.1). If the quartz sensors detect both, measurements are carried out at station 1 (10.5), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data from station 1 is then output to the computational system (10.7).

Subsequently, an assessment is made by station 1 whether the detected aircraft is indeed an aircraft or some other vehicle/object (10.6). If no, the process ceases (10.6.1). If yes, the aircraft is subsequently detected by force sensors (10.8). The force sensors then assess the aircraft and detect if the aircraft and runweight are present (10.9). If no, the process ceases (10.9.1). If yes, the aircraft is subsequently detected at station 2 (10.11). Measurements are carried out at station 2, for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data from station 2 is then output to the computational system (10.13).

A final assessment is carried out at station 2 to determine whether the detected aircraft is indeed an aircraft or some other vehicle/object (10.12). If no, the process ceases (10.12.1). If yes, the final sensor triggers completion of the assessment (10.14) and a notification is provided to the computational system (10.15). The final sensor is a loop and/or a camera, or a combination thereof, which will be located a calculated distance from the last runweight weight & balance sensing device. The precise distance will be calculated and configured for installation based on an aircraft traversing speed (no acceleration or deceleration) range of 3 to 15 km/h.

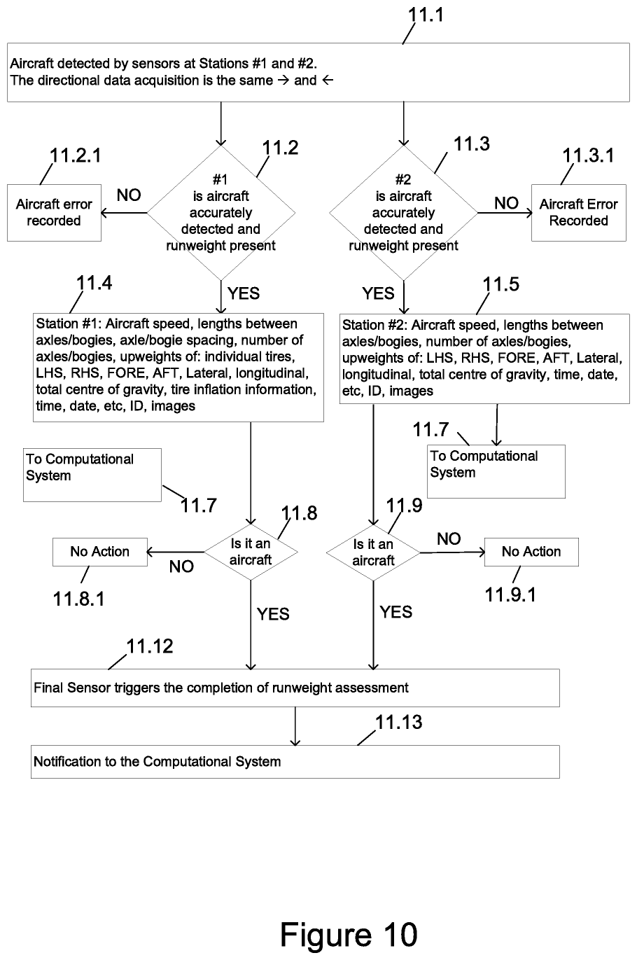

Referring to FIG. 10, there is provided a process flow of the system depicted in FIG. 1d. Firstly, the aircraft is detected at stations 1 and 2 (11.1). Simultaneously, station 1 and 2 respectively assess the aircraft and detect if the aircraft and runweight are present (11.2, 11.3). If station 1 does not detect either, an error is recorded and the process ceases (11.2.1). If station 2 does not detect either, an error is recorded and the process ceases (11.3.1).

If both stations 1 and 2 detect the presence of the aircraft and runweight, measurements are carried out at each respective station (11.4, 11.5), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data from each station is then output to the computational system (11.7).

Subsequently, an assessment is made by each station whether the detected aircraft is indeed an aircraft or some other vehicle/object (11.8, 11.9). If no, the process ceases (11.8.1, 11.9.1). If yes, the final sensor triggers completion of the assessment (11.12) and a notification is provided to the computational system (11.13). The final sensor is a loop and/or a camera, or a combination thereof, which will be located a calculated distance from the last runweight weight & balance sensing device. The precise distance will be calculated and configured for installation based on an aircraft traversing speed (no acceleration or deceleration) range of 3 to 15 km/h.

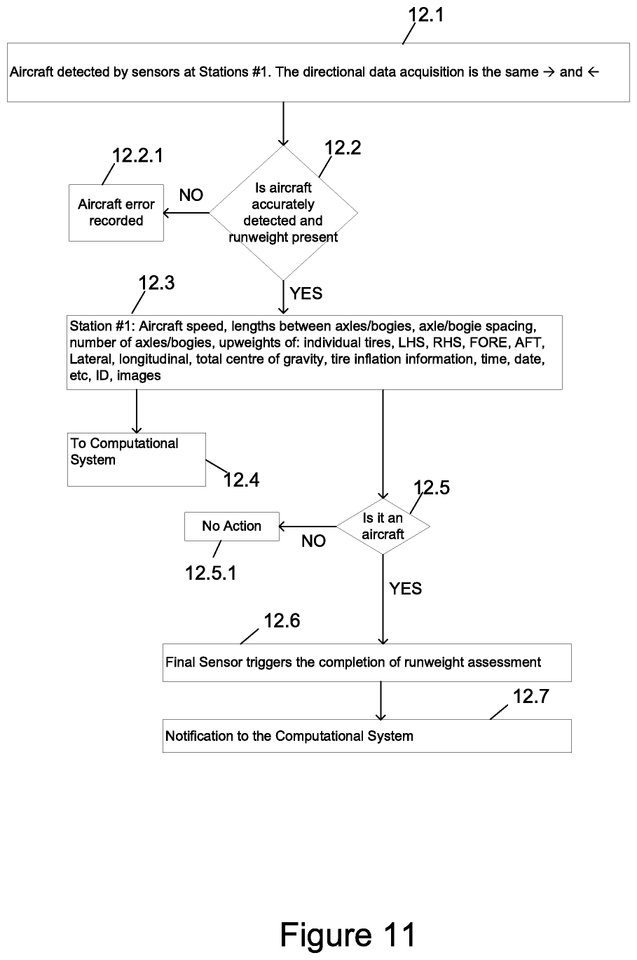

Referring to FIG. 11, there is shown a process flow of the system depicted in FIG. 1e/f. Firstly, it is determined if an aircraft is detected at station 1 (12.1). Then an assessment is carried out if the aircraft is detected accurately and for runweight (12.2). If no, an error is recorded (12.2.1). If yes, measurements are carried out at station 1 (12.3), for example, aircraft speed, length between axles/bogies, axle/bogie spacing, number of axles/bogies, runweights of individual tires, LHS, RHS, FORE, AFT, lateral, longitudinal, total centre of gravity, tyre inflation information, time, date, ID, images, and so forth. Processed data is then output to the computational system (12.4).

Subsequently, an assessment is made whether the detected aircraft is indeed an aircraft or some other vehicle/object (12.5). If no, the process ceases (12.5.1). If yes, the final sensor triggers completion of the assessment (12.6) and a notification is provided to the computational system (12.7). The final sensor is a loop and/or a camera, or a combination thereof, which will be located a calculated distance from the last runweight weight & balance sensing device. The precise distance will be calculated and configured for installation based on an aircraft traversing speed (no acceleration or deceleration) range of 3 to 15 km/h.

It should be noted that the aforementioned embodiments allow 0.05% accuracy when weighing an aircraft when stationary and 0.5% accuracy when weighing an aircraft dynamically (up to speeds of 15 km/h). In this regard, the accuracy is highly desirable.

It should also be noted that in the aforementioned systems, redundancy, integrity, as well as accuracy is improved by increasing a quantity of sensors. Furthermore, a greater quantity of sensors also limits downtime when failure occurs, as there will be back up sensors to fulfil operational requirements, and can enable maintenance and repair using a pre-scheduled timetable.

It should also be appreciated that the aforementioned systems are installed in the taxiway/runway apron and not on the actual runway.

There is also provided a method for determining a toll and/or landing fees payable for an aircraft, the toll and/or landing fees being for utilising an aircraft landing venue. The landing fees can be dependent on a duration that the aircraft remains at the aircraft landing venue. The method comprises measuring real-time parameters of the aircraft; and determining the toll and/or landing fees for the aircraft based on the real-time parameters of the aircraft.

The real-time parameters can be used to calculate the toll payable based on, for example, a once off fee (count and pay basis), on a tariff per quantitative weight/load, by designated an overall average tariff by weight/load per airport per quantitative weight/load traversing the runweight system, in any other manner negotiated with the airport/airline authorities and can be on a pay as you go basis, daily, weekly, monthly, per quarter or annually, a daily amount each airline pays regardless of how many aircraft are weighed, and so forth.

The real-time parameters can also be used to calculate the landing fees payable based on, for example, a once off fee (per entry basis), on a time duration basis calculated from a time when the aircraft traverses the runweight system, in any other manner negotiated with the airport/airline authorities, and so forth.

It should be appreciated that measuring real-time parameters of the aircraft can be using the systems and methods as described in the preceding paragraphs, or even other systems and methods.

Whilst there have been described in the foregoing description preferred embodiments of the present invention, it will be understood by those skilled in the technology concerned that many variations or modifications in details of design or construction may be made without departing from the present invention.

1. A system for determining real-time parameters of an aircraft, the system comprising:
at least two sensing apparatus, each of the at least two sensing apparatus including a plurality of in-ground sensors; and
at least one processing apparatus to process data received from the at least two sensing apparatus,
wherein the processing apparatus generates said real-time parameters of the aircraft based on the data received from the at least two sensing apparatus; and
wherein a positioning of the at least two sensing apparatus is determined by a type of the aircraft being measured.

2. The system of claim 1, wherein the in-ground sensors comprises:
weight sensors; and
presence sensors.

3. The system of claim 1, wherein each of the sensing apparatus further includes imaging sensors, the imaging sensors being configured to enable identification of the aircraft.

4. The system of claim 1, wherein the at least two sensing apparatus are positioned in a row to enable determination of presence of an aircraft, aircraft separation, speed measurement and aircraft classification.

5. The system of claim 1, further including at least one weather determination station, the at least one weather determination station being to obtain at least one weather parameter selected from a group consisting of: apparent wind speed, wind direction, air temperature, pavement temperature, relative humidity, pavement humidity, barometric pressure, heat index, wind chill, ceilometer, lateral and longitudinal wind draft, and air density.

6. The system of claim 1, further including a visual display apparatus configured to indicate the real time parameters of the aircraft.

7. The system of claim 1, wherein the at least one processing apparatus is configured to carry out at least one of the following tasks: loop detection, direction detection, speed detection, force detection based on frequency, speed acquisition, determination of acceleration of the aircraft, determination of deceleration of the aircraft, compensating input signals to external parameters, conditioning input signals to external parameters, and linearizing of input signals to external parameters.

8. The system of claim 1, wherein the real time parameters are selected from a group consisting of:
(a) the aircraft's individual tire weight, mass/force;
(b) all individual bogies/axles weight, mass/force;
(c) accumulated lateral tyre(s)/bogie(s)/axle(s) weight, mass/force;
(d) accumulated longitudinal tyre(s)/bogie(s)/axle(s) weight, mass/force;
(e) total accumulated weight, mass/force of all tyre(s)/bogie(s)/axle(s);
(f) lateral tyre(s)/bogie(s)/axle(s) weight, mass/force distribution;
(g) longitudinal tyre(s)/bogie(s)/axle(s) weight, mass/force distribution;
(h) maximum take off weight, mass/force;
(i) longitudinal centre of gravity;
(j) lateral centre of gravity;
(k) total centre of gravity;
(l) tyre detection;
(m) aircraft speed;
(n) validation of constant velocity of the aircraft;
(o) tyre inflation irregularities;
(p) identification indicia pertaining to the aircraft;
(q) left to right aircraft loading balance information and distribution;
(r) fore to aft aircraft loading balance information and distribution; and
(s) the aircraft loading and balance information and distribution.

9. The system of claim 1, wherein the real-time parameters determine a toll payable for the aircraft, the toll being for utilising an aircraft landing venue.

10. A method for determining a toll payable for an aircraft, the toll being for utilising an aircraft landing venue, the method comprising:
measuring real-time parameters of the aircraft; and
determining the toll for the aircraft based on the real-time parameters of the aircraft.

11. The method of claim 10, wherein the measurement of the real-time parameters of the aircraft is carried out using a system comprising:
at least two sensing apparatus, each of the at least two sensing apparatus including a plurality of in-ground sensors; and
at least one processing apparatus to process data received from the at least two sensing apparatus,
wherein the processing apparatus generates said real-time parameters of the aircraft based on the data received from the at least two sensing apparatus; and
wherein a positioning of the at least two sensing apparatus is determined by a type of the aircraft being measured.

12. A method for determining a landing fee payable for an aircraft, the landing fee being for utilising an aircraft landing venue, the method comprising:
measuring real-time parameters of the aircraft; and
determining the landing fee for the aircraft based on a duration that the aircraft is at the aircraft landing venue, the duration being measured from a juncture when measuring the real-time parameters of the aircraft.

13. The method of claim 12, wherein the measurement of the real-time parameters of the aircraft is carried out using a system comprising:
at least two sensing apparatus, each of the at least two sensing apparatus including a plurality of in-ground sensors; and
at least one processing apparatus to process data received from the at least two sensing apparatus,
wherein the processing apparatus generates said real-time parameters of the aircraft based on the data received from the at least two sensing apparatus; and
wherein a positioning of the at least two sensing apparatus is determined by a type of the aircraft being measured.

14. A system for determining real-time parameters of an aircraft, said system including:
(a) at least two sensing apparatus, each of the at least two sensing apparatus including a plurality of in-ground sensors; and
(b) at least one processing apparatus configured to perform the steps of:
(i) receiving data from the at least two sensing apparatus;
(ii) determining from said data if a runweight is present;
(iii) if a runweight is present, then determining if an aircraft is present;
(iv) if an aircraft is present, then determining:
(A) a type of the aircraft;
(B) a centre of gravity of the aircraft;
(C) an up weight of the aircraft; and
(D) a maximum take off weight,
(v) determining if the centre of gravity, the up weight and the maximum take off weight are within the required allowances.

15. The system claimed in claim 14, configured to perform the steps of:
(a) sending data representing that the centre of gravity, the up weight and the maximum take off weight are within the required allowances.

16. The system of claim 15, wherein the in-ground sensors comprises:
weight sensors; and
presence sensors.

17. The system of claim 14, wherein each of the sensing apparatus further includes imaging sensors, the imaging sensors being configured to enable identification of the aircraft.

18. The system of claim 14, wherein the at least two sensing apparatus are positioned in a row to enable determination of presence of an aircraft, aircraft separation, speed measurement and aircraft classification.

19. The system of claim 14, further including at least one weather determination station, the at least one weather determination station being to obtain at least one weather parameter selected from a group consisting of: apparent wind speed, wind direction, air temperature, pavement temperature, relative humidity, pavement humidity, barometric pressure, heat index, wind chill, ceilometer, lateral and longitudinal wind draft, and air density.

20. The system of claim 14, further including a visual display apparatus configured to indicate the real time parameters of the aircraft.

21. The system of claim 14, wherein the at least one processing apparatus is configured to carry out at least one of the following tasks: loop detection, direction detection, speed detection, force detection based on frequency, speed acquisition, determination of acceleration of the aircraft, determination of deceleration of the aircraft, compensating input signals to external parameters, conditioning input signals to external parameters, and linearizing of input signals to external parameters.

22. The system of claim 14, wherein the real time parameters are selected from a group consisting of:
(a) the aircraft's individual tire weight, mass/force;
(b) all individual bogies/axles weight, mass/force;
(c) accumulated lateral tyre(s)/bogie(s)/axle(s) weight, mass/force;
(d) accumulated longitudinal tyre(s)/bogie(s)/axle(s) weight, mass/force;
(e) total accumulated weight, mass/force of all tyre(s)/bogie(s)/axle(s);
(f) lateral tyre(s)/bogie(s)/axle(s) weight, mass/force distribution;
(g) longitudinal tyre(s)/bogie(s)/axle(s) weight, mass/force distribution;
(h) maximum take off weight, mass/force;
(i) longitudinal centre of gravity;
(j) lateral centre of gravity;
(k) total centre of gravity;
(l) tyre detection;
(m) aircraft speed;
(n) validation of constant velocity of the aircraft;
(o) tyre inflation irregularities;
(p) identification indicia pertaining to the aircraft;
(q) left to right aircraft loading balance information and distribution;
(r) fore to aft aircraft loading balance information and distribution; and
(s) the aircraft loading and balance information and distribution.

23. The system of claim 14, wherein the real-time parameters determine a toll payable for the aircraft, the toll being for utilising an aircraft landing venue.
